(19) United States
(12) Patent Application Publication
(10) Pub. No.: US 2026/0229568 A1
(43) Pub. Date: Aug. 6, 2026

(54) SYSTEM FOR SOLID-STATE ELECTRICITY STORAGE AND SOLID-STATE ELECTRICITY GENERATION

(71) Applicant: Marko KLOBCIC, Zgornje Gorje (SI)

(72) Inventor: Marko KLOBCIC, Zgornje Gorje (SI)

(21) Appl. No.: 19/148,477

(22) PCT Filed: Jan. 24, 2024
(86) PCT No.: PCT/IB2024/050654

§ 371 Date: Jul. 16, 2025

(30) Foreign Application Priority Data
Jan. 31, 2023 (SI) P-202300019

(51) Int. Cl. H01M 8/065; C25B 1/04; C25B 1/26; C25B 15/08; C25C 3/34; C25C 7/00; H01M 8/04082; H01M 8/04537

(52) U.S. Cl. CPC H01M 8/065; C25B 1/04; C25B 1/26; C25B 15/081; C25B 15/083; C25C 3/34; C25C 7/002; H01M 8/04216; H01M 8/04552

(57) ABSTRACT

The invention relates to a system for solid-state electricity storage and solid-state electricity generation that allows electricity to be stored when the renewable energy sources produce excess electricity and electricity to be generated when the electricity demand on the market exceeds the electricity production from renewable energy sources. The system comprises a solid-state electricity storage device having a first electrolysis device for producing chlorine from a melt of zinc chloride and solid zinc, a second electrolysis device for producing hydrogen from water, a first reactor for producing hydrogen chloride, and a vessel with a water sprayer for producing hydrochloric acid. The system further comprises a solid-state electricity generation device having a second reactor for reacting zinc and hydrochloric acid to produce hydrogen and a fuel cell for generating electricity.

### FIELD OF INVENTION

The invention relates to a device and process for solid-state electricity storage and a device and process for solid-state electricity generation and a system for solid-state electricity storage and solid-state electricity generation.

### PRIOR ART

Climate change and global warming are forcing mankind to reduce greenhouse gas emissions, especially CO₂. CO₂ emissions are caused by the combustion of fossil fuels such as coal, natural gas, fuel oil, petrol, etc. In the field of energy generation, thermal power plants are being replaced by plants based on renewable energy sources such as wind or solar power.

A drawback of generating electricity from renewable energy sources is that electricity generation is highly dependent on current weather conditions. Electricity generation cannot therefore be planned in advance. Electricity production thus fluctuates widely and is not necessarily in line with the needs of the electricity market.

The problem is currently solved by equipping renewable energy plants with electricity storage devices (batteries, accumulators). When electricity production is higher than the market demand, the storage devices are filled, and when it is lower, the storage devices are emptied. Such a solution is suitable for regulating daily fluctuations in production and consumption, but is economically inefficient for regulating seasonal fluctuations.

### Technical Problem

The technical problem is how to provide a complete, safe, simple and efficient system for solid-state electricity storage and solid-state electricity generation that will allow electricity to be stored over longer periods of time.

### Solution to the Technical Problem

The technical problem is solved by a solid-state electricity storage device, comprising:
a storage tank of an aqueous zinc chloride solution,
a first conduit for feeding the aqueous zinc chloride solution from the storage tank of aqueous zinc chloride solution to a dryer,
a dryer comprising a first heating device for drying the zinc chloride and a first temperature gauge,
a second conduit for feeding the dried zinc chloride from the dryer to a first electrolysis device,
a first electrolysis device comprising a second heating device for heating the zinc chloride to a temperature greater than 290° C., preferably to a temperature between 310° C. and 330° C., most preferably to a temperature of about 320° C., a second temperature gauge, an anode in the form of a zinc plate and a cathode,
a zinc plate storage vessel,
a mechanism for discharging the zinc plates from the first electrolysis device into the zinc plate storage vessel and vice versa,
a third conduit for feeding chlorine from the first electrolysis device to a reactor,
a second electrolysis device comprising a fourth conduit for feeding water thereto,
a fifth conduit for the discharge of oxygen from the second electrolysis device,
a sixth conduit for feeding hydrogen from the second electrolysis device to a first reactor,
a first reactor comprising an arc burner for the production of hydrogen chloride,
a seventh conduit for feeding hydrogen chloride from the first reactor to a vessel,
a vessel comprising an eighth conduit for water supply, a sprayer for generating water droplets and a measuring device for measuring pH values,
a ninth conduit having a valve for the discharge of hydrochloric acid from the vessel into the hydrochloric acid storage tank,
a hydrochloric acid storage tank, and
a first control device.

The invention further relates to a solid-state electricity storage process comprising the following steps:
providing a solid-state electricity storage device,
drying of zinc chloride in a dryer,
feeding the dried zinc chloride to a first electrolysis device,
melting the zinc chloride in the first electrolysis device,
electrolysis of the zinc chloride to produce zinc in solid form and chlorine in gaseous form,
electrolysis of water to produce oxygen and hydrogen,
feeding chlorine and hydrogen to a first reactor having an arc burner to produce hydrogen chloride,
dissolving the hydrogen chloride in water to produce hydrochloric acid,
measuring the pH value of the hydrochloric acid; and
discharging the hydrochloric acid into the hydrochloric acid storage tank when the measured pH value of the hydrochloric acid is lower than a predetermined value.

The invention further relates to a device for generating solid-state electricity, comprising:
a hydrochloric acid storage tank,
a tenth conduit for feeding the hydrochloric acid from the hydrochloric acid storage tank to a second reactor,
a mechanism for feeding the zinc plates from the zinc plate storage vessel to the second reactor and vice versa,
a second reactor for reacting the zinc and hydrochloric acid,
an eleventh conduit for discharging the aqueous zinc chloride solution to the storage tank of aqueous zinc chloride solution,
a twelfth conduit for feeding the hydrogen from the second reactor to a fuel cell,
a fuel cell for generating electricity; and
a second control device.

The invention further relates to a process for generating solid-state electricity, comprising:
providing a device for generating electricity from a solid-state matter,
feeding zinc plates and hydrochloric acid to a second reactor,
reacting zinc and hydrochloric acid in the second reactor to produce hydrogen and an aqueous zinc chloride solution,
discharging the aqueous zinc chloride solution to the storage tank of aqueous zinc chloride solution,
feeding hydrogen and oxygen into a fuel cell to generate electricity.

A system for solid-state electricity storage and solid-state electricity generation of the invention comprises said device for solid-state electricity storage and said device for solid-state electricity generation.

An advantage of the system for solid-state electricity storage and solid-state electricity generation of the invention lies in that it allows electricity to be stored when the renewable energy sources produce excess electricity and electricity to be generated when the electricity demand on the market exceeds the electricity production from renewable energy sources. The system allows timely indefinite solid-state electricity storage, without energy being wasted while stored. The system is safe, simple and efficient.

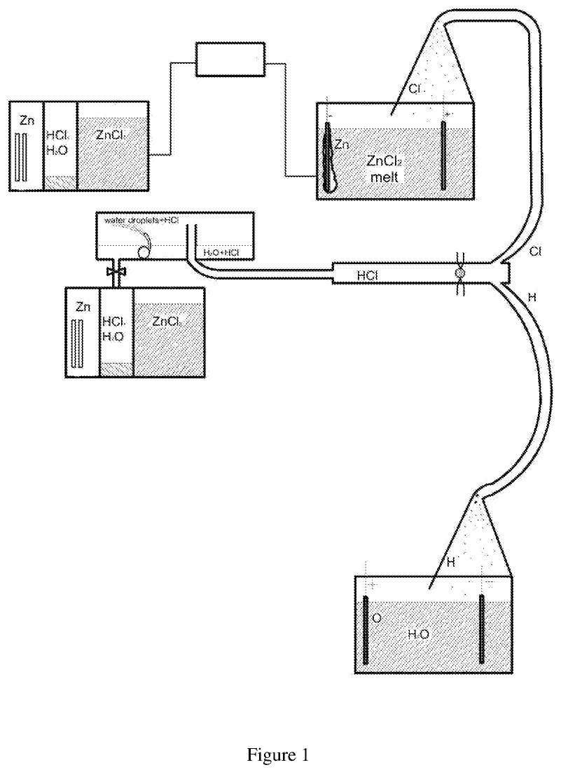

FIG. 1: Solid-state electricity storage device diagram

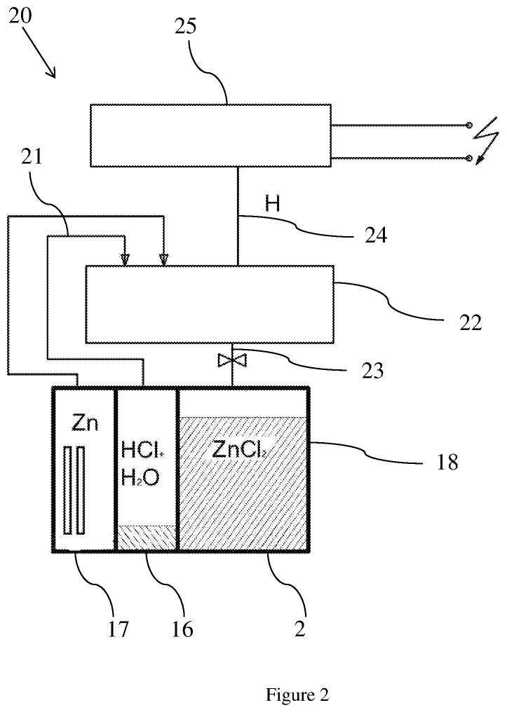

FIG. 2: Solid-state electricity generation device diagram

The invention is described in more detail hereinbelow.

The technical problem is solved by a solid-state electricity storage device 1, comprising:
a storage tank 2 of an aqueous zinc chloride solution,
a first conduit 3 for feeding the aqueous zinc chloride solution from the storage tank 2 of aqueous zinc chloride solution to a dryer 4,
a dryer 4 comprising a first heating device for drying the zinc chloride and a first temperature gauge,
a second conduit 5 for feeding the dried zinc chloride from the dryer 4 to a first electrolysis device 6,
a first electrolysis device 6 comprising a second heating device for heating the zinc chloride to a temperature greater than 290° C., preferably to a temperature between 310° C. and 330° C., most preferably to a temperature of about 320° C., a second temperature gauge, an anode in the form of a zinc plate and a cathode,
a zinc plate storage vessel 17,
a mechanism for discharging the zinc plates from the first electrolysis device into the zinc plate storage vessel 17 and vice versa, a third conduit 7 for feeding chlorine from the first electrolysis device 6 to a reactor,
a second electrolysis device 8 comprising a fourth conduit for feeding water thereto,
a fifth conduit for the discharge of oxygen from the second electrolysis device 8,
a sixth conduit 9 for feeding hydrogen from the second electrolysis device to a first reactor,
a first reactor 10 comprising an arc burner 11 for the production of hydrogen chloride,
a seventh conduit 12 for feeding hydrogen chloride from the first reactor to a vessel,
a vessel 13 comprising an eighth conduit for water supply, a sprayer 14 for generating water droplets and a measuring device for measuring pH values,
a ninth conduit 15 having a valve for the discharge of hydrochloric acid from the vessel into the hydrochloric acid storage tank,
a hydrochloric acid storage tank 16, and
a first control device.

The dryer 4 may be provided with a zinc chloride electrical conductivity meter. From the measurement of the electrical conductivity of zinc chloride, it is possible to deduce the water content of zinc chloride. When the measured electrical conductivity value reaches a predetermined value, the dried zinc chloride can be discharged from the dryer.

The first electrolysis device 6 may further be equipped with a level meter which operates by measuring the electrical conductivity of the melt. When the level of the zinc chloride melt drops below a predetermined level, the level meter detects this due to a change in electrical conductivity. The control device emits a signal to feed the dried zinc chloride powder to the first electrolysis device, which signal is emitted for a predetermined time interval.

The second conduit 5 for feeding the dried zinc chloride from the dryer to the first electrolysis device may be further divided into two sections with an intermediate arrangement of a storage tank for storing the dried zinc chloride, the first section of the second conduit being provided with a first screw conveyor for conveying the zinc chloride from the dryer to the storage tank and the second section of the second conduit being provided with a second screw conveyor for conveying the zinc chloride from the storage tank to the first electrolysis device. The first control device is responsible for switching on the first/second screw conveyor on the basis of a signal from the electrical conductivity meter/level meter.

The storage tank 2 of an aqueous zinc chloride solution, the hydrochloric acid storage tank 16, and the zinc plate storage vessel 17 can be accommodated in a common housing 18. It is further preferred that the housing 18 of the tanks is formed in the form of a universal or standard ISO or intermodal container designed for the storage of goods in intermodal transport—i.e. transport involving transhipment between different means of transport by road, rail and ship.

The first heating device may be formed by a first electric heater and/or a first heat exchanger that transfers the heat energy released when chlorine and hydrogen react to form hydrogen chloride to the dryer. The second heating device may be formed by a second electric heater or a combination of the second electric heater and second heat exchanger that transfers the heat energy released when chlorine and hydrogen react to form hydrogen chloride to the first electrolysis device. It is recommended that when the device is started, the zinc chloride is melted using a second electric heater and then the melt temperature is maintained using heat from the second heat exchanger. The heat exchangers improve the yield of the solid-state electricity storage device. The first and second heating devices are respectively controlled by the first control device on the basis of the signal from the first and second temperature gauges, respectively. It is recommended that the temperature in the dryer is between 100° C. and 290° C., preferably between 150° C. and 240° C.

It is recommended that the first reactor 10 is equipped with a safety device which monitors the presence of the arc flame of the arc burner 11 and stops the electrolysis process in the absence of the flame. This prevents the risk of explosion.

A mechanism for discharging the zinc plates from the first electrolysis device 6 into the zinc plate storage vessel 17 and vice versa can be provided with a first weight gauge. When the first mass gauge detects that the zinc plate in the first electrolysis device has reached a predetermined weight, it activates, via the first control device, said mechanism to remove the thickened zinc plate from the first electrolysis device and replace it with a thin one.

Said mechanism may further be equipped with a vibration device which is activated by the first control device after the mechanism has pulled the thickened zinc plate out of the melt. The purpose of the vibrating device is to drain as much of the zinc chloride melt as possible from the zinc plate.

The invention further relates to a solid-state electricity storage process comprising the following steps:
providing a solid-state electricity storage device 1,
drying of zinc chloride in a dryer 4,
feeding the dried zinc chloride to a first electrolysis device 6,
melting the zinc chloride in the first electrolysis device 6,
electrolysis of the zinc chloride to produce zinc in solid form and chlorine in gaseous form,
electrolysis of water to produce oxygen and hydrogen,
feeding chlorine and hydrogen to a first reactor 10 having an arc burner 11 to produce hydrogen chloride,
dissolving the hydrogen chloride in water to produce hydrochloric acid,
measuring the pH value of the hydrochloric acid; and
discharging the hydrochloric acid into the hydrochloric acid storage tank when the measured pH value of the hydrochloric acid is lower than a predetermined value.

The zinc chloride ZnCl₂ is stored in the storage tank 2 for the aqueous zinc chloride solution, from where it is pumped to the dryer 4 where the water is removed by drying. The dried zinc chloride is conveyed to the first electrolysis device 6 where it melts and is split by way of electrolysis to zinc and chlorine according the formula ZnCl₂→Zn+2Cl. The zinc is deposited on the zinc anode, while the chlorine is removed from the melt and fed into the first reactor 10 where it reacts with the hydrogen from the second electrolysis device 8 to form hydrogen chloride according to formula 2Cl+2H→2HCl. The hydrogen chloride is dissolved in the vessel 13 to give hydrochloric acid. When the appropriate concentration is reached, which is checked with a pH value meter, the hydrochloric acid is discharged into the hydrochloric acid storage tank 16. The process produces zinc plates and hydrochloric acid, which are stored until the need for electricity generation arises. In addition, the process produces oxygen, which can be released into the atmosphere or used as an oxidant to feed a fuel cell or as a by-product for some other purpose.

The invention further relates to a device 20 for generating solid-state electricity, comprising:
a hydrochloric acid storage tank 16,
a tenth conduit 21 for feeding the hydrochloric acid from the hydrochloric acid storage tank 16 to a second reactor 22,
a mechanism for feeding the zinc plates from the zinc plate storage vessel 17 to the second reactor 22 and vice versa,
a second reactor 22 for reacting the zinc and hydrochloric acid,
an eleventh conduit 23 for discharging the aqueous zinc chloride solution to the storage tank 2 of aqueous zinc chloride solution,
a twelfth conduit 24 for feeding the hydrogen from the second reactor 22 to a fuel cell 25,
a fuel cell 25 for generating electricity; and
a second control device.

A mechanism for feeding the zinc plates from the zinc plate storage vessel 17 to the second reactor 22 and vice versa may be equipped with a second weight gauge. When the second weight gauge detects that the zinc plate weight in the second reactor has droped below a predetermined weight, it activates, via the second control device, said mechanism to remove the thinned zinc plate from the second reactor and replace it with a thickened one.

The fuel cell 25 is further provided with a voltmeter. When the measured electrical voltage drops below a predetermined value, it means that the hydrogen supply to the fuel cell has been reduced or stopped. A second control device activates the discharge of the spent zinc chloride/water mixture from the second reactor 22 into the storage tank 2 for the aqueous zinc chloride solution, and a new supply of zinc plates and hydrochloric acid can be fed into the second reactor.

The invention further relates to a process for generating solid-state electricity, comprising:
providing a device 20 for generating electricity from a solid-state matter,
feeding zinc plates and hydrochloric acid to a second reactor 22,
reacting zinc and hydrochloric acid in the second reactor 22 to produce hydrogen and an aqueous zinc chloride solution,
discharging the aqueous zinc chloride solution to the storage tank 2 of aqueous zinc chloride solution,
feeding hydrogen and oxygen into a fuel cell 25 to generate electricity.

The system for solid-state electricity storage and solid-state electricity generation of the invention comprises said device 1 for solid-state electricity storage and said device 20 for solid-state electricity generation.

1. A solid-state electricity storage device comprising:
a storage tank of an aqueous zinc chloride solution,
a first conduit for feeding the aqueous zinc chloride solution from the storage tank of aqueous zinc chloride solution to a dryer,
a dryer comprising a first heating device for drying the zinc chloride and a first temperature gauge,
a second conduit for feeding the dried zinc chloride from the dryer to a first electrolysis device,
a first electrolysis device comprising a second heating device for heating the zinc chloride to a temperature greater than 290° C., preferably to a temperature between 310° C. and 330° C., most preferably to a temperature of about 320° C., a second temperature gauge, an anode in the form of a zinc plate and a cathode,
a zinc plate storage vessel,
a mechanism for discharging the zinc plates from the first electrolysis device into the zinc plate storage vessel and vice versa,
a third conduit for feeding chlorine from the first electrolysis device to a reactor,
a second electrolysis device comprising a fourth conduit for feeding water thereto,
a fifth conduit for the discharge of oxygen from the second electrolysis device,
a sixth conduit for feeding hydrogen from the second electrolysis device to a first reactor,
a first reactor comprising an arc burner for the production of hydrogen chloride,
a seventh conduit for feeding hydrogen chloride from the first reactor to a vessel,
a vessel comprising an eighth conduit for water supply, a sprayer for generating water droplets and a measuring device for measuring pH values,
a ninth conduit having a valve for the discharge of hydrochloric acid from the vessel into the hydrochloric acid storage tank,
a hydrochloric acid storage tank, and
a first control device.

2. The solid-state electricity storage device according to claim 1, characterized in that the drier is equipped with a meter of electrical conductivity of zinc chloride.

3. The solid-state electricity storage device according to claim characterized in that the first electrolysis device is equipped with a level meter which operates by measuring the electrical conductivity of the melt.

4. The solid-state electricity storage device according to claim 1, characterized in that the second conduit for feeding the dried zinc chloride from the dryer to the first electrolysis device is divided into two sections with an intermediate arrangement of a storage tank for storing the dried zinc chloride, the first section of the second conduit being provided with a first screw conveyor for conveying the zinc chloride from the dryer to the storage tank and the second section of the second conduit being provided with a second screw conveyor for conveying the zinc chloride from the storage tank to the first electrolysis device.

5. The solid-state electricity storage device according to claim 1, characterized in that the storage tank of an aqueous zinc chloride solution, the hydrochloric acid storage tank, and the zinc plate storage vessel are accommodated in a common housing.

6. The solid-state electricity storage device according to claim 5, characterized in that the housing of the tanks is formed in the form of a universal or ISO standard intermodal container.

7. The solid-state electricity storage device according to claim 1, characterized in that the first heating device is formed by a first electrical heater and/or a first heat exchanger that transfers the heat energy released when chlorine and hydrogen react to produce hydrogen chloride, into a dryer, and the second heating device is formed by a second electric heater or a combination of the second electric heater and second heat exchanger that transfers the heat energy released when chlorine and hydrogen react to produce hydrogen chloride, to the first electrolysis device.

8. The solid-state electricity storage device according to claim 1, characterized in that the first reactor is equipped with a safety device which monitors the presence of the arc flame of the arc burner and stops the electrolysis process in the absence of the flame.

9. The solid-state electricity storage device according to claim 1, characterized in that a mechanism for discharging the zinc plates from the first electrolysis device into the zinc plate storage vessel and vice versa is provided with a first weight gauge, said mechanism being preferably equipped with a vibration device.

10. A solid-state electricity storage process comprising the following steps:
providing a solid-state electricity storage device according to claim 1,
drying of zinc chloride in the dryer,
feeding the dried zinc chloride to the first electrolysis device,
melting the zinc chloride in the first electrolysis device,
electrolysis of the zinc chloride to produce zinc in solid form and chlorine in gaseous form,
electrolysis of water to produce oxygen and hydrogen,
feeding chlorine and hydrogen to the first reactor having the arc burner to produce hydrogen chloride,
dissolving the hydrogen chloride in water to produce hydrochloric acid,
measuring the pH value of the hydrochloric acid; and
discharging the hydrochloric acid into the hydrochloric acid storage tank when the measured pH value of the hydrochloric acid is lower than a predetermined value.

11. A device for generating electricity from a solid-state matter comprising:
a hydrochloric acid storage tank,
a conduit for feeding hydrochloric acid from the hydrochloric acid storage tank to a reactor,
a mechanism for feeding zinc plates from a zinc plate storage vessel to the reactor and vice versa
for reacting zinc and hydrochloric acid,
a conduit for discharging aqueous zinc chloride solution to a storage tank of aqueous zinc chloride solution,
a conduit for feeding hydrogen from the reactor to a fuel cell
for generating electricity in
a control device.

12. The device for generating electricity from a solid-state matter according to claim 11, characterized in that the mechanism for feeding the zinc plates from the zinc plate storage vessel to the second reactor and vice versa is equipped with a second weight gauge.

13. The device for generating electricity from a solid-state matter according to claim 11, characterized in that the fuel cell is equipped with a voltmeter.

14. A method for generating electricity from a solid-state matter comprising:
providing a device for generating electricity from a solid-state matter according to claim 11,
feeding zinc plates and hydrochloric acid to a second reactor,
reacting zinc and hydrochloric acid in the second reactor to produce hydrogen and an aqueous zinc chloride solution,
discharging the aqueous zinc chloride solution to the storage tank of aqueous zinc chloride solution,
feeding hydrogen and oxygen into a fuel cell to generate electricity.

15. A system for solid-state electricity storage and solid-state electricity generation comprising a device for solid-state electricity storage according to claim 1.

16. A system for solid-state electricity storage and solid-state electricity generation comprising a device for solid-state electricity generation according to claim 11.
